(19) United States
(12) Patent Application Publication
(10) Pub. No.: US 2005/0114177 A1
(43) Pub. Date: May 26, 2005

(54) System and method for accessing health care procedures

(76) Inventor: Patrick J. Sweeney, Portage, MI (US)

Correspondence Address: Warner Norcross & Judd LLp, 900 Fifth Third Center, 111 Lyon Street, N.W., Grand Rapids, MI, 49503-2487, US

(21) Appl. No.: 10/723,100

(22) Filed: Nov. 26, 2003

(51) Int. Cl. G06F 17/60

(52) U.S. Cl. 705/2

(57) ABSTRACT

A system for accessing health care processes includes a server, a workstation, a network and a procedure database. A user accesses the system by way of a graphical interface containing an image of a human body. By using a mouse, a user can view procedures relevant to particular areas of the human body. After selecting one of the listed procedures, the procedure is then displayed on a video display.

### BACKGROUND OF THE INVENTION

This invention relates to systems and methods for retrieving and accessing health care procedures at a healthcare organization.

Healthcare providers have a large number of policies and procedures that document proper methods of performing activities within the organization. Policies and procedures cover the full range of activities within the organization including actions performed on patients, administrative processes, maintenance procedures and the use of instruments and devices. As used herein, “healthcare process” refers generically to a procedure or a policy, or both. By way of example, there are various standardized processes for inserting a catheter, changing a dressing, for providing heating therapy using a heating pad or sanitizing a whirlpool bath. Obviously, a large organization could have hundreds of different unique healthcare processes.

Some of these healthcare processes are routine while others are performed less often. Some procedures are performed in emergency situations; others are performed under less stressful conditions. Some processes are lengthy and detailed; others are short. Additionally, procedures and policies may be regularly updated when equipment is replaced or when new medical information indicates a need to modify a procedure.

The people who perform the procedures and policies may have different education and experience levels. There could be doctors, interns, nurses, nurse's aides, home health providers or even healthcare organization clerical works. These people may not be assigned to work in the area where the procedure or policy is usually performed. Additionally, these people may speak different languages.

Customarily, the procedures and policies are maintained in a text file or a text database. Copies of procedures and policies most used in a particular location may be printed at different locations in the healthcare organization. A person desiring to perform a procedure or policy performs a key word search in an attempt to identify the proper procedure or policy, reads the procedure or policy, and then goes to another location and performs the described process.

The problems with such a method are obvious and many. In an emergent situation, going to a different location to access the file is not feasible. The key word search may not be viable if the person reading the book speaks a language different from the person who wrote the procedure. Procedures and polices often can be called different names by different people. Assuming the person who needs to perform the procedure successfully locates the relevant information and can understand the information in the procedure, the person may forget salient elements of the procedure.

Thus, an improved method and system for retrieving the health care processes is needed.

### BRIEF DESCRIPTION OF THE DRAWINGS

FIG. 1 is a diagram of a system for accessing and displaying healthcare organization procedures.

FIG. 2 is an interactive user interface for the system.

FIG. 3 is a procedure which could be displayed by the system.

FIG. 4 is a flowchart showing the operation of the system.

### DETAILED DESCRIPTION OF THE DRAWINGS

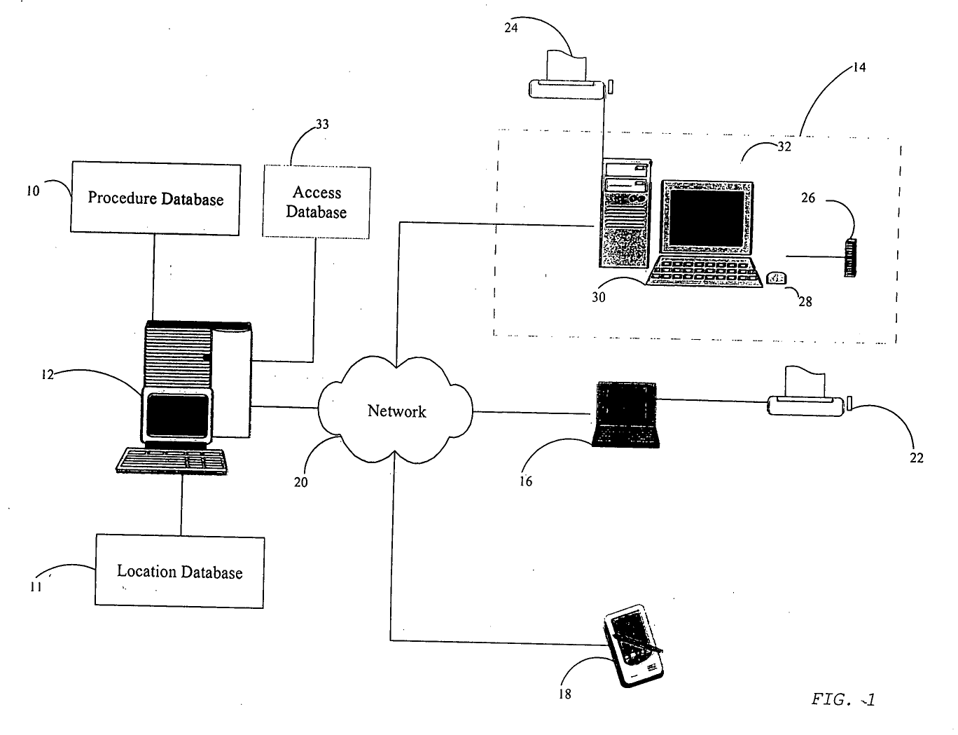

FIG. 1 shows a computer system for accessing and displaying healthcare organization schemas. Schema database 10 contains all or most of the policies procedures for a healthcare organization. Location database 11 contains location information regarding each device connected to the network and the procedures and policies most likely to be used at the location. Additionally, location database 11 would contain information about a procedure most likely to be used in a particular location of the healthcare organization.

Server 12 connects procedure and policy database 10 to workstation 14, notebook computer 16 and PDA (Personal Digital Assistant) 18 by way of network 20. A plurality of workstations, notebook computers and PDAs could be connected to network 20. Workstation 14, server 12 and network 20 form a computer network.

Network 20 could be any wired or wireless network. Printers 22, 24 are connected respectively to workstation 14 and notebook computer 16. While network 20 could be confined within the walls of a building, it would also be possible to extend the network to a satellite clinic remote from the building or even to a moving ambulance.

Workstation 14 contains an ID (identification) reader 26. ID reader 26 could be an RF (radio frequency) ID reader, a card reader, or any of the many other readers for detecting the specific identity of a user. Workstation 14 could include mouse 28, keyboard 30, and display device 32. Mouse 28 would have at least one button. As is well known, mouse 28 is used move a pointer on display device 32. By actuating the button on the mouse, workstation 14 may perform various functions.

Workstation 14 is used as an example. The principles discussed with reference to workstation 14 could be used by the other devices such as notebook computer 16 or PDA 18. A mouse is illustrative of a device to allow interaction with the computer. However, many cursor control devices could be used such as buttons, pads, finger-touch screens and voice command recognition.

Workstation 14 could be configured to allow general access to all healthcare organization procedures. Alternatively, a user approaching workstation 14 would be identified by ID reader 26, either by the user swiping a card or by the ID reader automatically reading the person's identify from the user's RF ID tag.

Procedure and policy database 10 contains a collection of healthcare organization procedures. Procedure and policy database 10 could have several database sets. One database set is procedures to be performed using inanimate objects within the building. For example, such a procedure would be the sanitizing a whirlpool or cleaning. A second database set would be procedures to be performed on people. For example, the procedure for changing a central line dressing could be included within this set. Obviously, other sets of procedures could be present as needed.

When requested, workstation 14 initiates an interactive program, hereinafter referred to as a client, to access procedure and policy database 10 via network 20. A suitable client to access procedure and policy database 10 could be a web browser, such as Internet Explorer, distributed by Microsoft. Obviously, many different types of client could be used to access procedure and policy database 10.

The web browser then displays a graphic display of a medical facility and a human body. The medical facility could be a hospital, an ambulance, or any other area, including a home, where medical care could be provided. A user moves mouse 28 to position a cursor over either the graphic display of the medical facility or the human body. The user then clicks mouse 28.

If the medical facility were clicked on, the user would be primarily accessing the inanimate objects within the building, and thus would be accessing policies. A diagram of the medical facility is then displayed. As the mouse is moved about the graphic of the medical facility, various drop-down menus would appear. The drop down menus would be associated with the location designated by the mouse. For example, if the mouse designated the operating room, procedures associated with the operating room would be displayed. If the mouse designated the lab, various procedures associates with the healthcare organization lab would be displayed.

When the appropriate room was identified, the mouse is clicked, and the system displays an image for that particular room or area of the medical facility. The image could be a picture, a sketch, or a panoramic 360 degree picture of the room. By manipulating the mouse or the keyboard, the entire area is displayed. A user could them use the mouse to point at various objects within the room. As the user points to objects within the room, procedures associated with each object would be displayed.

For example, if an examination room was displayed, objects such as a blood pressure monitor and a thermometer would be displayed. As the mouse moves over the objects, a drop down menu of the various procedures associated with the object is displayed. When the mouse is moved over a particular object and clicked, then the user is taken to an image of only that object.

The various procedures associated with the object are displayed. The user then selects one of the procedures by using the mouse. When selected, the procedure for that object would be displayed.

Information about the procedure is then shown in one of many different modes. First, a text description of the procedure could be displayed. A language translator assembled from appropriate software could translate the procedure from a first language, such as English, into a second language, such as Spanish. Second, a video could be displayed showing the procedure. Third, an instructional series of pictures could be displayed showing the procedure. A voice track could be played alone or concurrently with the visual display.

Alternatively, if the user clicked on the human body, the system accesses procedures related primarily to patients. The system displays a body. As the mouse moves across the body, various procedures relating to the area designated by the mouse are displayed. For example, if the mouse moved over the mouth, procedures relating to the mouth are displayed.

From the drop down menu, the user could select one of the procedures for the shoulder. Alternatively, the entire set of procedures for the shoulder could be displayed.

The menu of the entire procedures for the shoulder shows a graphic “thumbnail” for the procedure as well as a short text description of the procedure. The user could then select the appropriate procedure.

Again, information about the procedure is then shown in one of many different modes. First, a text description of the procedure could be displayed. Appropriate software could translate the procedure into various languages such as Spanish, English or Chinese. Second, a video could be displayed showing the procedure. Third, an instructional series of pictures could be displayed showing the procedure. A voice track could be played alone or concurrently with the visual display.

Once the desired procedure is selected, the user indicates that the procedure was commenced. Information relating to the start time and user is then stored in the central database. When the procedure is completed, the user then indicates that the procedure was performed. The time when the procedure was completed is also stored in the central database. Thus, the date, time, and location of the performance of the procedure as well as the person who performed the procedure are fully documented.

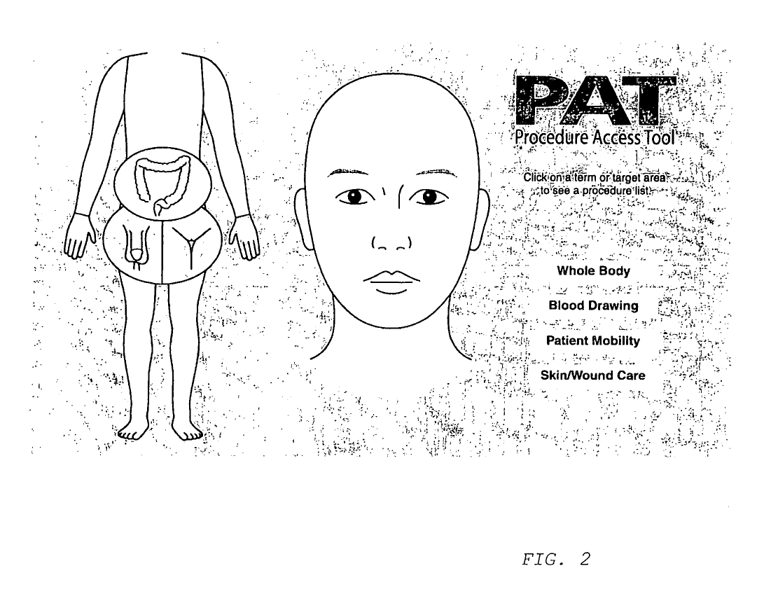

An interactive user interface to access medical facility procedures is shown in FIG. 2. The interactive user interface could be a graphical interface. The interactive user interface includes human body image 50. In one embodiment, as the mouse guides the cursor over human body image 50, a list of procedures for that body is would appear.

Alternatively, by clicking on the graphic, a different graphic, such as a second human body image or a third human body image, may appear place of the original. In this embodiment, the second human body image would show more detail of a particular area than the first human body image. Or, in another alternative embodiment, select areas of human body image 50 may be enlarged as the mouse travels over the body as if the mouse were a magnifying glass.

When the part of human body image 50 sufficiently identified, the user actuates a button on the mouse. A drop down menu of possible medical facility procedures which could be performed would then appear. A user could select one of the procedures from the list.

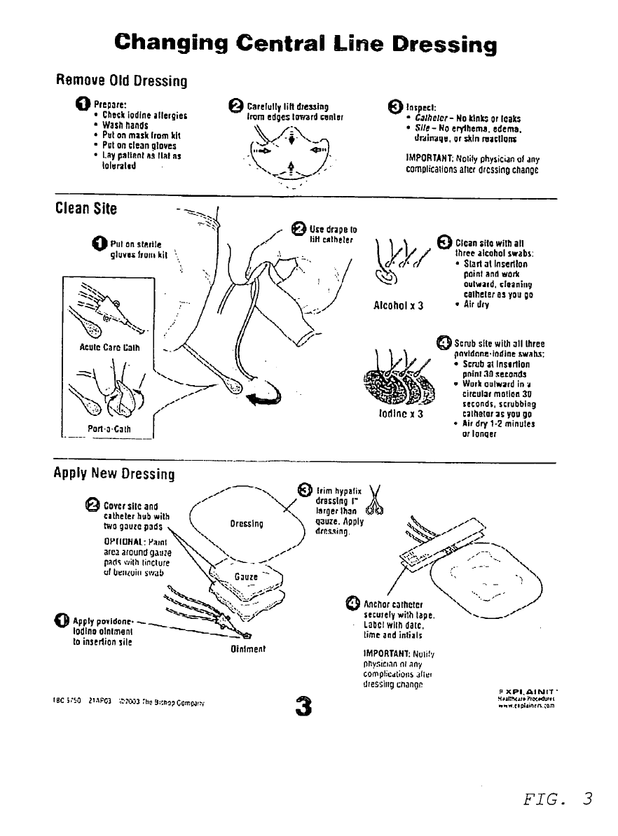

If a procedure was selected from the list, the procedure would be displayed. An example of the procedure is shown in FIG. 3. Preferably, the procedure would be explained on one page using a central graphic, limited text and a clear sequence of procedures. As noted above, the procedure could be accompanied by an audio presentation or video presentation, or both. Further, a user could select the language. If the system were equipped with a method to identify the user, then the procedure would be automatically displayed in the preferred language of the user.

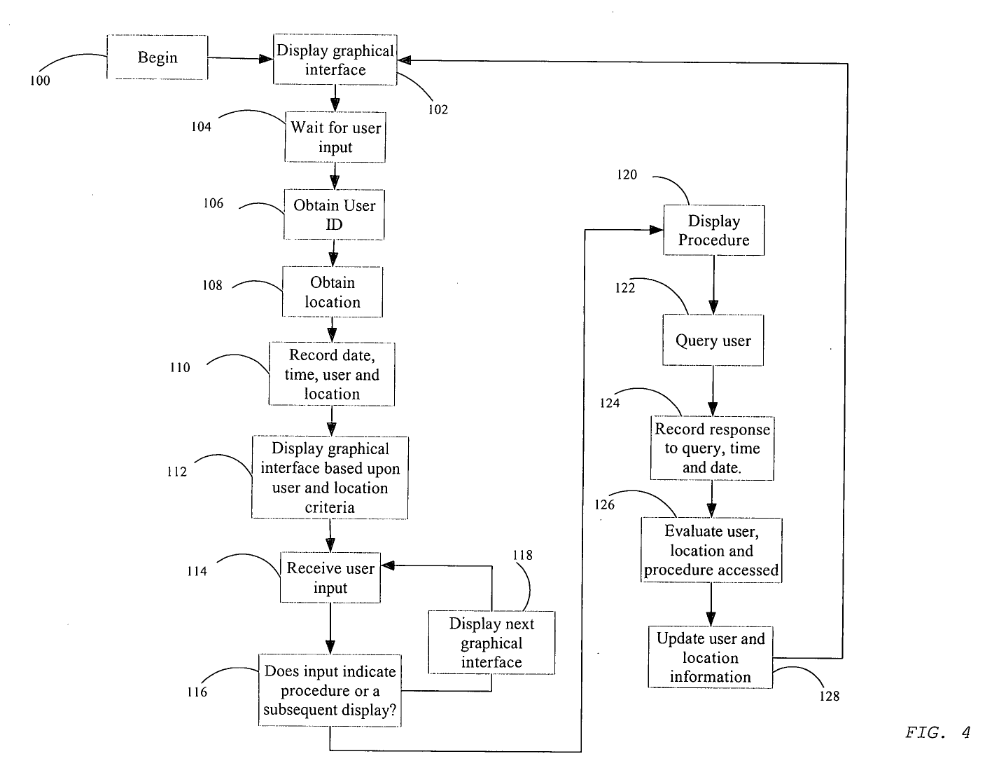

FIG. 4 is a flow chart for the operation of the system. The system is first initialized. Step 100. The graphic interface is displayed. Step 102. The picture for the graphic could be stored in memory located at workstation 14 or the picture could be downloaded from server 12 each time the system is accessed. The system then waits for an input from a user. Step 104.

When an input is received, the system obtains the identification of the user. Step 106. The user identification could be obtained in many different ways. The user could type into workstation 14 a username and password. If the user were wearing an RFID (Radio Frequency Identification) tag, the workstation could automatically read the identity of the user from the RFID tag. If the user were accessing the procedure system by way of PDA 18 or notebook computer 16, then PDA 18 or notebook computer 16 may have a user ID stored in its memory which is transmitted to server 12.

The location of the user when accessing the system is then identified. Step 108. This could be accomplished by the user typing in his location. Alternatively, if the procedure were accessed by way of a workstation, the location of the user could be identified by accessing location database 11. Location database 11 would use the identification number for each workstation, such as the IP (Internet Protocol) address, to define the location of the user. If the user were using a PDA 18 or notebook computer 16 and accessing server 12 by way of a wireless network, the location of the user could be determined by determining the IP address for the wireless access point interacting with notebook computer 16 or PDA 18.

The user ID, the location, the time and the date are then stored in access database 33. Based upon the user ID, the user's location, and the time, a graphic is displayed for the particular user. Step 112. For example, if the user were a nurse in the X-ray lab, then procedures most often of use to her would be displayed. On the other hand, if the user were a night orderly in a long term care facility, a graphic for procedures most likely to be used by him would be displayed. In this manner, procedures of most interest to each user would be quickly and automatically displayed. Thus, during an emergency, selection of the appropriate procedure would be efficient and speedy.

After the graphic is displayed, the system would wait for input from the user. Step 114. The system would then evaluate the user input. Step 116. The user could select a different display, in which case a new graphic would be displayed. Step 118. If the user selected a procedure, then the procedure would be displayed. Step 120.

Following viewing of the procedure by the user, the system would then query the user regarding the use of the procedure. Step 122. For example, a user could be queried as to whether the procedure was performed, and, if it was performed, whether the procedure was performed successfully. The response to the queries are then stored in access database 33 along with date and time information. Step 124.

After this information is stored in the access database 33, the system then updates user information and the location information for later use when the user accesses the system at a later time or if the system is accessed from the same location. Step 128. Thus, the system dynamically creates a database of which procedures are most likely to be used by which users at which locations. For example, if a user continually accesses a procedure, the system could automatically bring up the procedure or it could provide the user with an option to access the procedure.

The system then displays the original graphics interface and waits for further interaction. Step 102.

The system as heretofore described provides many benefits. The likelihood of caregiver error caused by using improper or incorrect methods is decreased. The productivity of health care givers is increased by providing easily accessible instructions for accomplishing medical facility procedures. The caregiver no longer is required to rely on memory. Further, standardization of the procedures and the nomenclature is enhanced.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. A computer system for displaying health care processes comprising:
a network;
a server coupled to the network and in communication with a health care process database, the health care process database storing a plurality of health care processes, the server programmed to receive signals representative of a unique health care process and the server programmed to send in response to the signals information illustrative of the health care process;
a computer coupled to the network, the computer programmed to display an interactive user interface for selecting a health care process, communicate with the server when a user selects a health care process; receive information illustrative of the health care process from the server, decode information; and display the health care process to the user.

2. The computer system of claim 1 where the interactive user interface is a graphical interface.

3. The computer system of claim 2 where the graphical interface includes a human body image.

4. The computer system of claim 3 where the computer includes a mouse for interacting with a first human body image.

5. The computer system of claim 4 where the mouse is used to move a pointer over the first human body image.

6. The computer system of claim 5 where the computer is programmed to display a menu of different health care processes when the mouse is placed over a portion of the first human body image.

7. The computer system of claim 6 where the computer is programmed to magnify a portion of the first human body image when the mouse is placed over a portion of the first human body image.

8. The computer system of claim 7 where the computer is programmed to present a second human body image when the mouse is placed over a portion of the first human body image and a button on the mouse is actuated.

9. The computer system of claim 8 where the computer is programmed to present a third human body image when the mouse is placed over a portion of the second human body image and the button on the mouse is actuated.

10. The computer system of claim 9 where the health care process contains text.

11. The computer system of claim 10 where the health care process contains text and graphical images.

12. The computer system of claim 11 where the health care process contains an audio presentation.

13. The computer system of claim 12 where the health care process contains a video presentation.

14. The computer system of claim 13 where the computer system includes a language translator for converting the health care process from a first language to a second language.

15. A computer implemented method for displaying a health care process to a user comprising:
displaying a first interactive user interface screen on a display device;
in response to user selection, displaying a plurality of user interface screens enabling the user to select a health care process; and
displaying the health care process on the display device.

16. The method of claim 15 further comprising the step of displaying a health care process list.

17. The method of claim 16 where the first interactive user interface screen is a first human body image.

18. The method of claim 17 where the step of displaying a health care process list is caused by user interaction with the first human body image.

19. The method of claim 18 where user interaction with the first human body image comprises the steps of using a mouse to move a pointer to an area of the first human body image.

20. The method of claim 19 where the user interaction with the human body comprises the step of actuating a button on the mouse when the pointer points to an area of the first human body image.

21. The method of claim 20 further comprising the step of displaying a second human body image in response to the user interaction with the first human body image.

22. The method of claim 21 where the step of displaying the health care process on the display device includes the step of displaying a text description of the health care process.

23. The method of claim 22 where the step of displaying the health care process on the display device includes the step of playing an audio description of the health care process.

24. The method of claim 23 where the step of displaying the health care process on the display device includes the step of playing a video of the health care process.

25. The method of claim 24 further comprising the step of determining a user identity.

26. The method of claim 25 further comprising the step of determining a user location.

27. The method of claim 26 further comprising the step of forming a first subset of health care processes based upon the user identity.

28. The method of claim 27 further comprising the step of displaying the first subset of health care processes.

29. The method of claim 28 further comprising the step of forming a second subset of health care processes based upon the user location.

30. The method of claim 29 further comprising the steps of:
determining a date and a time when the computer implemented method was used; and
recording in an access database the date, the time and the user identity.

31. The method of claim 30 further comprising the steps of:
determining a date and a time when the computer implemented method was used; and
recording in an access database the date, the time and the user location.

32. The method of claim 31 further comprising the steps of:
determining a user location; and
recording the user location in the access database.

33. The method of claim 32 further comprising the steps of:
determining a specific procedure retrieved by the computer implemented method; and
recording the specific procedure retrieved in the access database.

34. The method of claim 33 further comprising the steps of:
determining the first subset of health care processes by analyzing the access database.

35. The method of claim 34 further comprising the steps of:
determining the second subset of health care processes by analyzing the access database.
